(19) United States
(12) Patent Application Publication
(10) Pub. No.: US 2009/0006941 A1
(43) Pub. Date: Jan. 1, 2009

(54) PASSWORD ENTRY APPARATUS

(75) Inventor: Hiroshi Yoshida, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Osaka (JP)

(21) Appl. No.: 12/163,545

(22) Filed: Jun. 27, 2008

(30) Foreign Application Priority Data
Jun. 29, 2007 (JP) 2007-173358

(51) Int. Cl. G06F 3/048

(52) U.S. Cl. 715/227

(57) ABSTRACT

A television (password entry apparatus) creates and stores a table for selection and entry of a password character. The table includes: a password character matrix in which characters that make up a password (hereinafter referred to as “password characters”) are arranged in M rows and N columns; M numbers of row heading information in the rows of the matrix; and N numbers of column heading information in the columns of the matrix. The row heading information and the column heading information in the table are randomly created. When a user selects and enters row heading information and column heading information by using a remote control, a password character that corresponds to the row heading information and the column heading information selected and entered by the user is input into the television.

### BACKGROUND OF THE INVENTION

1. Field of the Invention

The present invention relates to a password entry apparatus, and more particularly relates to a technique for preventing password leakage.

2. Description of the Related Art

In recent years, computers that can be connected to a network have become widespread. When such a computer is connected to a secured site on a network, the computer sometimes prompts a user to enter a password. When the password is entered, the computer sends the user-entered password to the server for the site. The server then compares the received password with a password registered in advance. When the passwords match, the server sends the site information to the computer.

This kind of computer displays a software keyboard on which characters are arranged and a cursor that moves in response to user operations on a display connected to the computer. By manipulating the cursor, a user selects characters on the software keyboard to enter a password. However, this entry method has a problem that, when the display is placed where a third person can easily view the display, the person may look at the cursor position and thereby know the password.

In view of the above problem, Japanese laid-open patent publication No. Hei 9-274531 discloses a technique of changing arrangement of numeric keys displayed on the software keyboard. However, this technique has a problem that, when a password has a character, it may be troublesome for a user to find a key corresponding to a target character.

Japanese Utility Model No. 3086701 and Japanese laid-open patent publication No. 2004-126973 disclose a technique in which the display position of a given character displayed on a display is stored as a password and the password is entered by designating the display position of the given character. Japanese laid-open patent publication No. Hei 9-190237 discloses a password entry technique in which password information can be entered by operating a given operation key with a cursor positioned at a given region. However, these techniques cannot solve the above described problem because a third person can guess an entered password by attentively following relative movements in entry operations.

Japanese laid-open patent publication No. 2006-343873 discloses a password entry technique in which a software keyboard, a real cursor, and a dummy cursor are displayed when a password is entered. However, in this technique, key arrangement on the software keyboard is fixed. Therefore, a third person may look at the position of the real cursor and thereby know the password.

### SUMMARY OF THE INVENTION

An object of the present invention is to provide a password entry apparatus that can make it hard for third persons to know a password even when a user enters the password in a place where third persons can view the entry, thus preventing password leakage.

According to an aspect of the present invention, this object is achieved by a password entry apparatus comprising: table creating means for creating a table for selection and entry of a password character, the table including: a password character matrix in which characters that make up a password (hereinafter referred to as “password characters”) are arranged in M rows and N columns; M numbers of row heading information in the rows of the matrix; and N numbers of column heading information in the columns of the matrix, display means for displaying the table created by the table creating means; and selection and entry means for selecting and entering row heading information and column heading information that correspond to a user desired password character from among the row heading information and the column heading information displayed on the display means.

When a user selects and enters row heading information and column heading information by using the selection and entry means, a password character that corresponds to the row heading information and the column heading information selected and entered by the user is input into the password entry apparatus.

With the above configuration, a password character that corresponds to the row heading information and the column heading information selected and entered by a user is entered. In other words, unlike conventional techniques, a character itself at the cursor is not entered as a password. Therefore, even when a user enters a password in a place where third persons can view the entry, it is hard for third persons to know the password. Accordingly, password leakage can be prevented.

Preferably, the table creating means randomly creates the row heading information and the column heading information. With his configuration, even when the row heading information and the column heading information can be viewed by third persons, it is hard for third persons to know a password because the row heading information and the column heading information are created randomly. Accordingly, password leakage can be prevented.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a perspective view of a television system including a television embodying the present invention and a remote control;

FIG. 2 is a block diagram showing the internal configuration of the television;

FIG. 3 is a block diagram showing the internal configuration of the remote control;

FIG. 4 is an illustration showing an example of a password selection and entry screen; and

FIG. 5 is an illustration showing another example of a password selection and entry screen.

### DESCRIPTION OF THE PREFERRED EMBODIMENTS

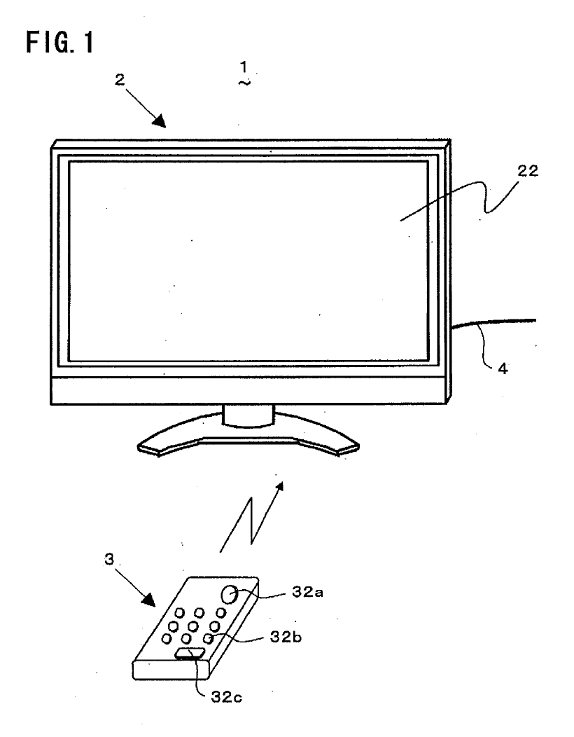

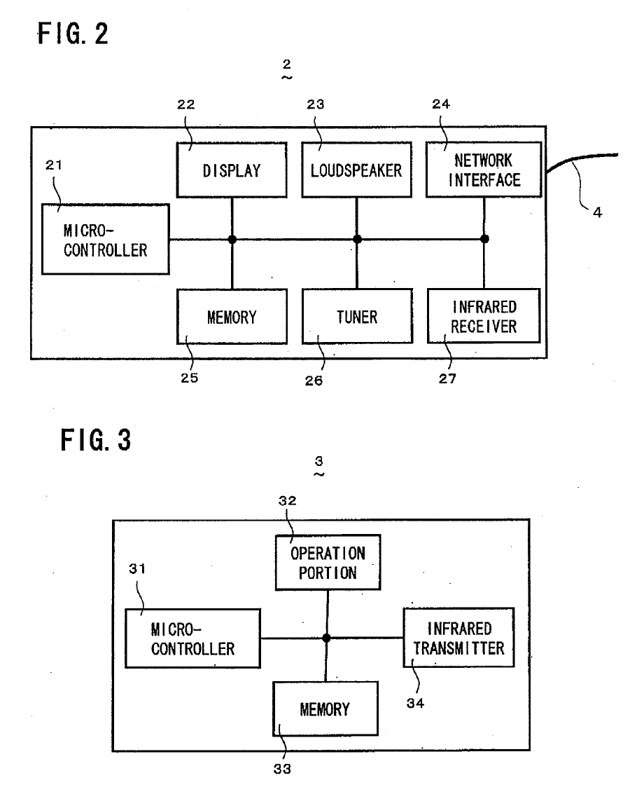

Referring now to FIG. 1 and FIG. 2, a television (password entry apparatus) embodying the present invention is described. It is to be noted that the following description of preferred embodiment of the present invention has been presented for purposes of illustration and description, and is not intended to be exhaustive or to limit the present invention to the precise form disclosed.

FIG. 1 shows an external view of a television system 1 including a television 2 and a remote control 3 used for operating the television 2. FIG. 2 is a block diagram showing the internal configuration of the television 2. FIG. 3 is a block diagram showing the internal configuration of the remote control 3.

As shown in FIG. 2, the television 2 comprises: a display 22 that displays television programs (hereinafter referred to as “TV programs”), various kinds of messages, and so on; a loudspeaker 23 that outputs sound in a TV program for example; a tuner 26 that receives a TV program; and an infrared receiver 27 that receives infrared signals transmitted from the remote control 3.

The television 2 further comprises: a network interface 24 connected to a network cable 4 for connection to a network such as the Internet; a microcontroller 21 that controls each component in the television; and a memory 25 that stores data, programs for operating the microcontroller 21, and so on.

The television 2 can be connected to a network and display information acquired via the network on the display 22. Further, on the display 22, the television 2 can display a password table for use in entry of characters such as a password. The password table is described later in detail.

The microcontroller 21 functions as table creating means recited in the claims.

As shown in FIG. 3, the remote control 3 comprises: an operation portion 32 that is operated by a user to enter a command to operate the television 2; an infrared transmitter 34 that transmits infrared signals based on the command entered via the operation portion 32; a microcontroller 31 that controls each component in the remote control 3; and a memory 33 that stores programs to control the microcontroller 31 and data such as codes for infrared signals.

The operation portion 32 has an arrow key 32a (see FIG. 1) used, for example, for manipulating a cursor displayed on the display 22 of the television 2, a numeric keypad 32b (see FIG. 1) used for various operations such as changing TV channels, and an ENTER key (selection and entry means) 32c (see FIG. 1) used for confirming selections for entry of a password or the like. The numeric keypad 32b has numeric keys of “0” to “9”.

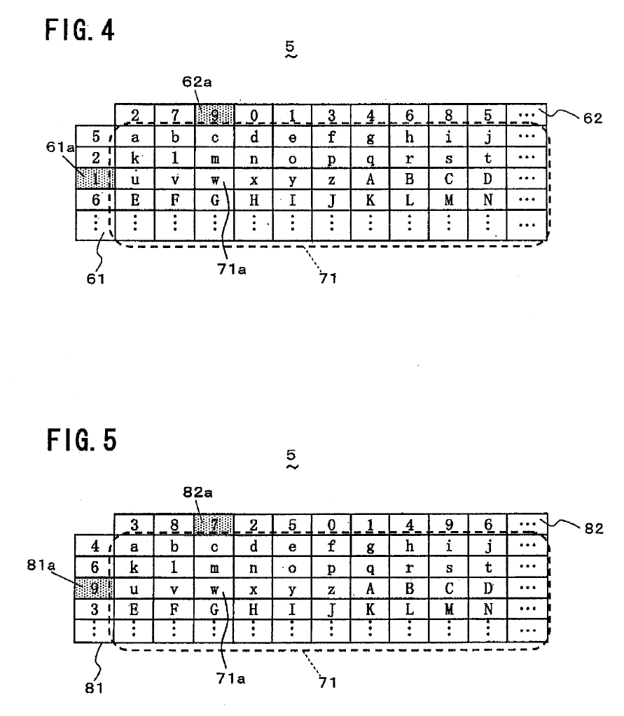

Referring now to FIG. 4, how to enter a password on the television 2 is described. FIG. 4 shows an example of a password table (table) 5 displayed on the display 22.

The password table 5 has: a password character matrix 71 in which cells are arranged in M rows and N columns (where M and N are natural numbers equal to or larger than one); M numbers of row heading information 61 in the rows of the matrix 71; and N numbers of column heading information 62 in the columns of the matrix 7.

Each cell in the password character matrix 71 is assigned to each of password characters including numbers, characters, and symbols. In the example shown in FIG. 4, alphabetic characters are assigned in the password character matrix 71 for simplicity in description. Password characters may include any one of numbers, characters, and symbols.

Each cell for the row heading information 61 and the column heading information 62 is assigned to a number. A number assigned to each cell for the row heading information 61 is unique. A number assigned to each cell for the column heading information 62 is also unique. The numbers assigned to the cells for the row heading information 61 and the column heading information 62 can be randomly re-created.

Referring now to FIG. 4, a procedure to select and enter a password character “w” 71a is described. First, a user operates a key on the numeric keypad 32b that corresponds to a number “1” 61a of the row heading information 61, and then presses the ENTER key 32c. Subsequently, the user operates a key on the numeric keypad 32b that corresponds to a number “9” 62a of the column heading information 62, and then presses the ENTER key 32c. Thereby, the password character “w” 71a, which corresponds to the number “1” 61a of the row heading information 61 and the number “9” 62a of the column heading information 62, is selected in the password character matrix 71 to be input into the television 2.

Referring now to FIG. 5, an example is described where the numbers assigned to the cells for the row heading information and the column heading information have been randomly re-created. FIG. 5 illustrates a password table 5 in this example.

The password table 5 shown in FIG. 5 is similar to that shown in FIG. 4 except for the numbers assigned to the cells for row heading information 81 and column heading information 82. The row heading information 81 has M numbers arranged in an order different from that in the row heading information 61 shown in FIG. 4. The column heading information 82 has N numbers arranged in an order different from that in the column heading information 62 shown in FIG. 4.

A procedure to select and enter a password character “w” 71a in the password table 5 shown in FIG. 5 is now described. First, a user operates a key on the numeric keypad 32b that corresponds to a number “9” 81a of the row heading information 81, and then presses the ENTER key 32c. Subsequently, the user operates a key on the numeric keypad 32b that corresponds to a number “7” 82a of the column heading information 82, and then presses the ENTER key 32c. Thereby, the password character “w” 71a, which corresponds to the number “9” 81a of the row heading information 81 and the number “7” 82a of the column heading information 82, is selected in the password character matrix 71 to be input into the television 2.

As described above, according to the television 2 of this embodiment, the entered password character is the character in the password character matrix 71 that corresponds to the row heading information 61 or 81 and the column heading information 62 or 82. In other words, unlike conventional techniques, a character at the cursor is not selected and entered as a password character. Therefore, even when the display 22 is placed where third persons can view it, it is hard for third persons to know the password. Accordingly, password leakage can be prevented.

Further, even if the row heading information 61 or 81 and the column heading information 62 or 82 are viewed by a third person, characters assigned to the cells for the row heading information 61 or 81 and the column heading information 62 or 82 are randomly re-created. Thereby, even when a user enters a password in a place where third persons can view the entry, it is hard for third persons to know the password itself. Accordingly, password leakage can be prevented.

The present invention has been described above using a presently preferred embodiment, but those skilled in the art will appreciate that various modifications are possible. For example, a password entry apparatus according to the present invention may be a system comprising a computer that can be connected to the Internet and a display connected to the computer, wherein a user operates the computer for the selection and entry on a password table displayed on the display.

This application is based on Japanese patent application 2007-173358 filed Jun. 29, 2007, the contents of which are hereby incorporated by reference.

What is claimed is:

1. A password entry apparatus comprising:
table creating means for creating a table for selection and entry of a password character, the table including: a password character matrix in which characters that make up a password (hereinafter referred to as “password characters”) are arranged in M rows and N columns; M numbers of row heading information in the rows of the matrix; and N numbers of column heading information in the columns of the matrix,
display means for displaying the table created by the table creating means; and
selection and entry means for selecting and entering row heading information and column heading information that correspond to a user desired password character from among the row heading information and the column heading information displayed on the display means,
wherein when a user selects and enters row heading information and column heading information by using the selection and entry means, a password character that corresponds to the row heading information and the column heading information selected and entered by the user is input into the password entry apparatus.

2. The password entry apparatus according to claim 1,
wherein the table creating means randomly creates the row heading information and the column heading information.
